(19) United States
(12) Patent Application Publication
(10) Pub. No.: US 2018/0037312 A1
(43) Pub. Date: Feb. 8, 2018

(54) Saucer Car

(71) Applicant: Hsiang-Shien Chen, Diamond Bar, CA (US)

(72) Inventor: Hsiang-Shien Chen, Diamond Bar, CA (US)

(21) Appl. No.: 15/330,102

(22) Filed: Aug. 8, 2016

(51) Int. Cl. B64C 11/20; B60F 5/02; F16H 48/20; B63H 5/07; B64C 39/00; F16H 48/06; B64C 37/00; B60F 3/00

(52) U.S. Cl. CPC B64C 11/20; B64C 37/00; B60F 5/02; B60F 3/0061; B63H 5/07; B64C 39/001; F16H 48/06; F16H 48/20; F16H 2048/204

(57) ABSTRACT

The basic of my invention is to use a more powerful engine then that in current car and to modify its structure and handling. This saucer car can drive in current narrow roadway with the retractable propeller. When obstacle in front, with the new “differential”, it can diverse power vertically, in that way to convert it into a helicopter. In Case the obstacle is a lake or river, the umbrella bottom, acting as propeller too, makes the car floating and sails on water. The propellers are rotated in opposite direction in order to keep car in neutral direction.

Since mini car is getting much smaller and lighter the engine power requirement is lighting up. The price tag to make a flying car will be more affordable and easier. My idea is using the current manipulation of a car, which ordinary people already know how. When is needed, it can fly from driveway, at allocated shoulder space on the road, at lake shore or sea shore, it can sails as a ship. The followings are in consideration:
1) The car needs a more powerful engine
2) Need lighter structure, the material are most of fiberglass or aluminum
3) The car should be waterproof at bottom, move as inverse umbrella, which has propeller design
4) The car will he saucer shape to have more even woight
5) The car should be fly and sailing straight without rotation to avoid vertigo
6) The Propeller of helicopter need to fold like a bird wing, in order to drive on regular roadway.
   When prepare to fly, it need a larger shoulder space to unfold the propeller.
7) The main requirements in additional to current cars are:
   a) Vertical, top and bottom, 2 propellers
   b) Car differential need be convertible, Lock and Unlock, for car and vertical fly situation
   c) Additional front and back propellers
   d) Additional transmission stick to control front and back propeller when helicopter in hover position to move forward. (this can adopt current helicopter measure too)
   e) The Propeller movement need opposite each other direction controlled at the differential box
   f) Vertical Fins attach to main wheels for direction control when driving wheel is handled
   g) Drop down pad when braking while in flying or sailing
      As the above idea, the following designs and drawings is requiring your honor to judge the feasibility.

Sincerely, Hsiang-Shien Chen

### SPECIFICATION

The following utility design is to modify the structure and control mechanic of the current car with the combo functions: Drive on land; Fly in air; Sail in water.
1) Drive on land: same as current car in structure and handling
   But in order to drive in current roadway, the long propellers are foldable by a joint,
   which is operated by a small motor similar to the closing device of a car window as show in FIG. 1.
2) Fly in air: The “ DIFFERENTIAL”, in the car for wheel diving, will covert power to vertical upper and lower propellers driving as in FIG. 3. Both propellers move in opposite directions at “ DIFFERENTIAL.” box. The lower propeller designed as an inverse umbrella in order for water sailing purpose. Forward moving is depended on 2 propellers mounted in the front and rear. Those move in opposite manner.
3) Sail in water: The reverse umbrella acting as floating cup, the vertical axle is a sealed cylinder at both ends as FIG. 3. The forward movement is depend on 2 propellers mounted in the front and rear as FIG. 4. The vertical 2 propellers also add the floating power of the car.

### Explanation of Drawing

FIG. 1: is the bird eye view of the saucer car (big circle), folding joint, (small circle). The joint is sandwich or biscuit like structure, in order to enforce the strength of propellers. The folding or unfolding is controlled by window motor in current car.

Fig.2: is the bird eye view of the saucer car (big circle), 4 wheels (sausage shape), front and back 2 wheels are passive wheels.

FIG. 3: demonstrates the differential box to convert the land driving to helicopter driving. The box in the center has locking and unlocking gears wheels, which is controlled by differential stick as shown in FIG. 6. The differential at center bottom is fixed, it is similar to ordinary front wheel drive. The half circle represents the reverse umbrella propeller.

FIG. 4: is the side view of saucer car

FIG. 5: is the posterior view of the saucer car

FIG. 6: is the regular car handling stick, driving wheel, brake, gas pedal, plus add on differential stick for functional change of air, land and sea and another stick for moving forward .

FIG.7: is to demonstrate current car gear box modification for front and rear propeller control and helicopter differential box

My claims are:

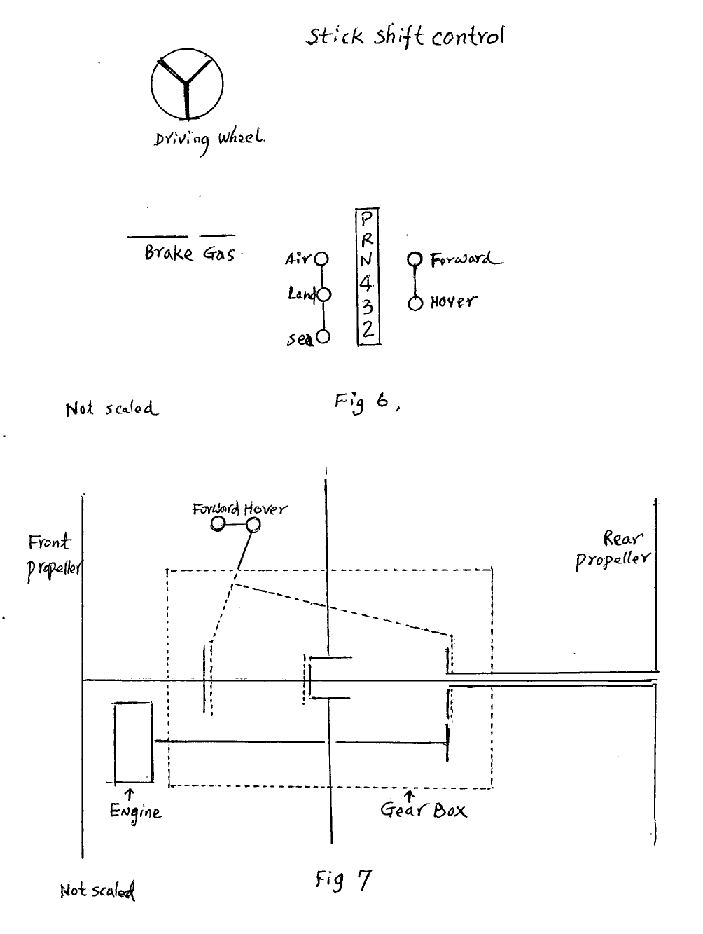

1) Differential Converter as in FIG. 3, FIG. 6 & FIG. 7

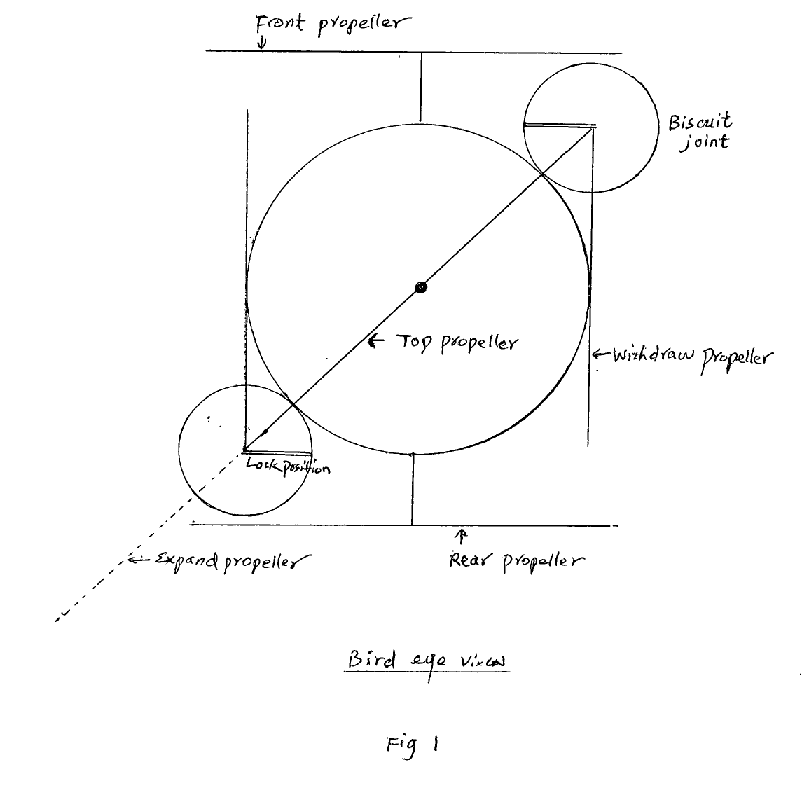

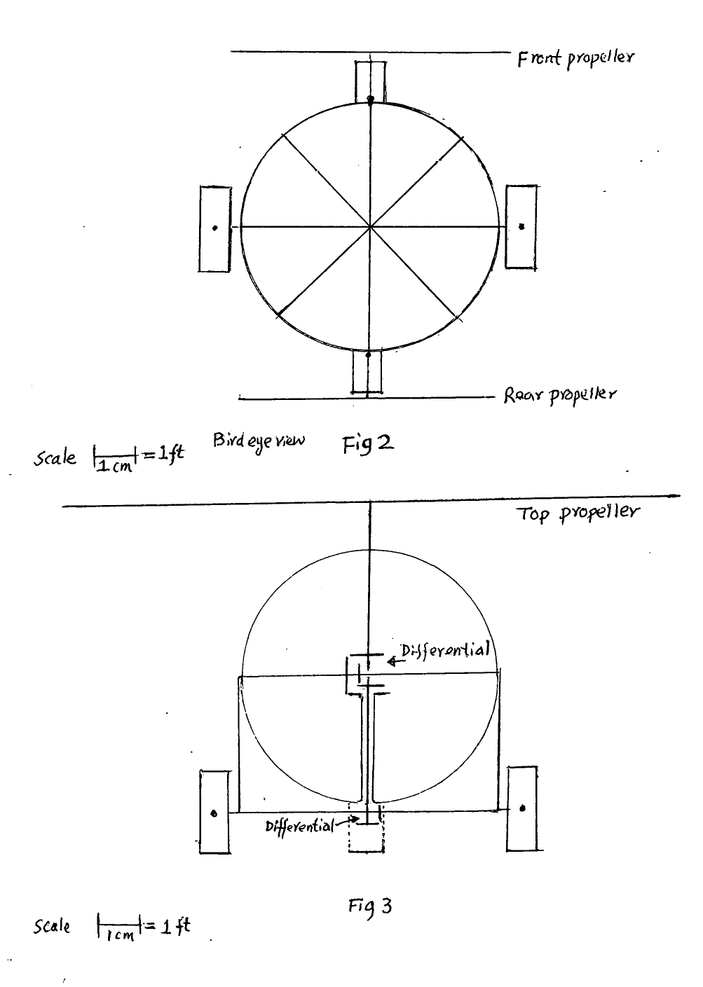

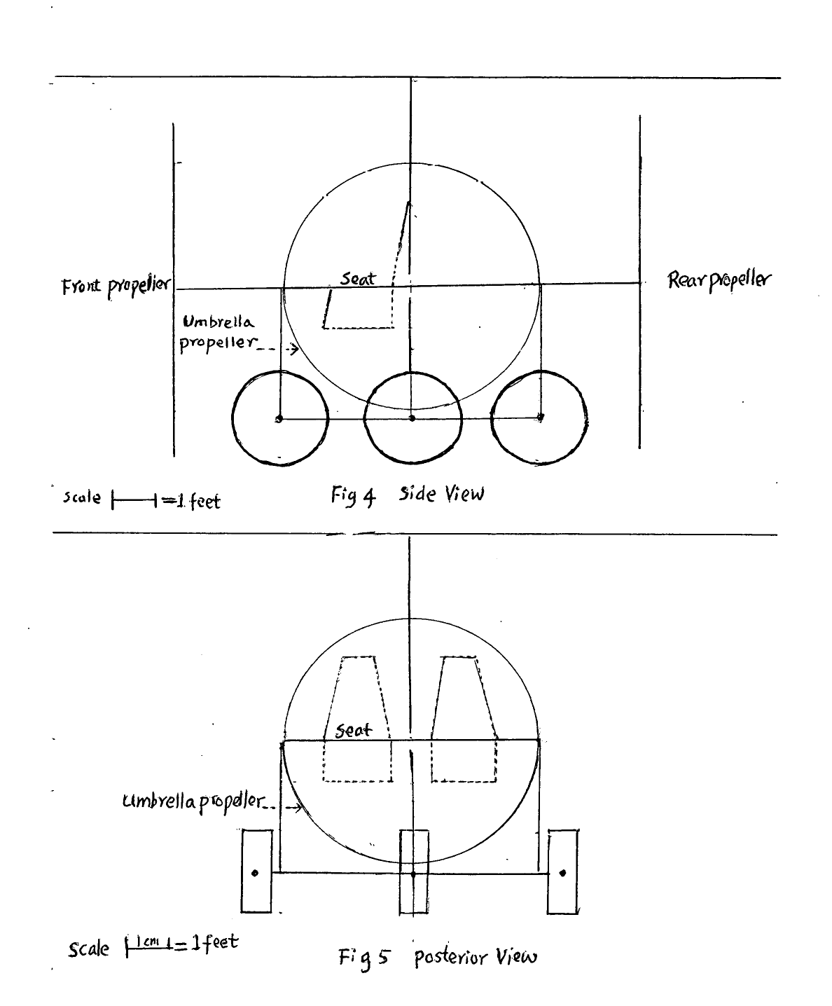

2) Propeller Joint as in FIG. 1

3) Reverse Umbrella Design of Propeller as in FIG. 3
